(19) United States
(12) Patent Application Publication
(10) Pub. No.: US 2025/0250117 A1
(43) Pub. Date: Aug. 7, 2025

(54) TRANSPORT BAG, SUPPORT HOOK, TRANSPORT DEVICE, AND OVERHEAD CONVEYOR SYSTEM

(71) Applicant: VANDERLANDE INDUSTRIES B.V., Veghel (NL)

(72) Inventors: Cornelis Sebastianus Maria VERHOEVE, Veghel (NL); Petrus Theodorus Cornelis VERVOORT, Veghel (NL); Sander Bernard Wilhelmus VAN ROOSMALEN, Veghel (NL)

(21) Appl. No.: 18/854,471

(22) PCT Filed: Mar. 31, 2023
(86) PCT No.: PCT/EP2023/058526

§ 371 Date: Oct. 4, 2024

(30) Foreign Application Priority Data
Apr. 6, 2022 (DE) 10 2022 203 414.7

(51) Int. Cl. B65G 17/32; B65G 17/20

(52) U.S. Cl. CPC B65G 17/32; B65G 17/20

(57) ABSTRACT

The present invention relates to a transport bag for an overhead conveyor system, said transport bag comprising: a suspension device for suspending the transport bag from a support hook; a front wall; and a rear wall. The rear wall can be coupled to and disengaged from the front wall by means of a coupling mechanism in a lower region of the rear wall. The front wall comprises a flexible planar material. The rear wall comprises two wall elements which are connected to one another in a pivotable manner and shaped such that together they form a filling opening of the transport bag, which filling opening extends in part over the two wall elements.

### TECHNICAL FIELD

The present invention relates to a transport bag for an overhead conveyor system, the transport bag comprising a suspension device for suspending the transport bag on a support hook, a front wall, and a rear wall. The present invention furthermore relates to a support hook for supporting a transport bag of this kind, a transport device for an overhead conveyor system, and an overhead conveyor system of this kind.

### BACKGROUND

Overhead conveyor systems comprising transport bags are known in principle from the prior art, these transport bags normally being moved directly or via a special support hook on rails or conveying devices.

A peculiarity of each transport bag is the way in which this is to be filled with or emptied of transport goods. Various solutions are known for this. For example, a transport bag is known from EP 2 792 620 A1. The transport bag comprises a rigid support wall connected to a support element, and a flexible goods retaining wall which, together with the support wall, forms a support bag that is closed at the bottom and on two opposite sides. The length of the band-shaped retaining wall can be variably adjusted to the transport of different goods the length of the band-shaped retaining wall required for the transport of the goods being removable from a retaining wall reservoir, and a portion of the retaining wall that is not required remaining in the retaining wall reservoir. These transport bags can be filled with goods at the open sides. In a further variant of the transport bag known from EP 2 792 620 A1, the support wall and goods retaining wall are pivotably connected to one another for opening and closing the transport bag. In the open state, the support wall of the transport bag lying on the conveying table is loaded with goods, and subsequently the goods retaining wall is pivoted over the support wall by unrolling from the retaining wall reservoir, for fixing the goods and closing the transport bag.

A further transport bag comprising a rigid support wall is known from EP 2 130 968 A1, which transport bag is connected, in its upper region, to the upper region of a flexible bottom side wall, via a pivotable bracket. The support wall and the bottom side wall each have coupling means in their lower regions, in order to be detachably connected to one another. The support wall comprises actuation means in the upper region, for opening and closing the coupling. Raising the pivotable bracket in a loading station moves the flexible bottom side wall away from the support wall, resulting in a gap between the two walls, which can be used for filling the transport bag with goods.

A transport bag comprising a support wall is also known from EP 3 521 214 A1, which bag comprises a front wall and a rear wall and can be switched between a closed state and an open state. For switching between the closed state and open state, the front wall and the rear wall are connected to one another or disengaged from one another in their lower region. In the upper region, the front wall and rear wall are interconnected via a one-piece loading frame, via which goods can be introduced into the transport bag. In the suspended position of the transport bag, however, the loading frame also hangs vertically downwards, and its filling opening is covered by the front wall, which makes the loading more difficult.

In order to overcome this disadvantage, a transport bag is proposed in DE 10 2019 205 980 A1 which provides a rotation limitation on the loading frame, such that the loading frame no longer extends in a vertical plane in the suspended position of the transport bag, and the front wall is spaced apart from the rear wall of the transport bag.

However, a disadvantage of this solution is that the transport bag is less space-saving in the empty state. Furthermore, in the case of filling from above, a one-piece loading frame restricts the dimensions of the goods which can be introduced into the transport bag and requires a precise orientation of the transport bag relative to a loading station.

A disadvantage of the solutions known from the prior art for filling through a side gap is furthermore that precautions have to be taken for automatic filling of the transport bag, which prevent the goods from falling out during filling. It is for example necessary to ensure that the goods do not slide out of the bag on the other side of the gap opposite the filling side. In the case of goods being laid on a horizontal support wall of an initially fully open transport bag, too, it is necessary for the goods to be prevented from slipping down before the bag is closed.

### DESCRIPTION OF THE INVENTION

Against this background, an object of the present invention is that of providing a transport bag for an overhead conveyor system, and a support hook for supporting the transport bag, which allow for simple filling in differently designed loading stations, both from above and from a side, as well as simple emptying.

This object is achieved by a transport bag according to claim 1, a support hook for supporting a transport bag according to claim 9, a transport device for an overhead conveyor system according to claim 14, and overhead conveyor systems according to claim 16 and claim 19. Advantageous embodiments of the invention follow from the dependent claims.

According to a first aspect of the present invention, a transport bag for an overhead conveyor system is provided, which transport bag comprises a suspension device for suspending the transport bag from a support hook, a front wall, and a rear wall, the rear wall being able to be coupled to and disengaged from the front wall by means of a coupling mechanism in a lower region of the rear wall. In this case, the front wall comprises a flexible planar material. The rear wall comprises two wall elements which are connected to one another in a pivotable manner and shaped such that together they form a filling opening of the transport bag, which filling opening extends in part over the two wall elements.

The fact that the filling opening extends over the two wall elements that are connected to one another in a pivotable manner means that the filling opening covers a large surface of the rear wall of the transport bag, which can be used for loading. Thus, goods having large dimensions, in particular bulky objects such as cardboard boxes, can be more easily introduced into the transport bag. Furthermore, jamming of the goods in the filling opening during the loading process can be prevented. A further advantage of the pivotable connection of the wall elements is that the wall elements can be tilted relative to one another. As a result, for example, the part of the filling opening that is located on one wall element can be oriented in a different direction from the other part of the filling opening that is located on the other wall element. Thus, for example, one wall element can be oriented upwards and the other to the side, i.e. the filling opening then simultaneously has a part that is open at the top and a part that is open at the side. This allows for loading from above and also for loading from a lower position from the side, in a loading position. The side with respect to a conveying direction, to which the part open to the side faces in the loading position, depends on the orientation of the transport bag. Rotating the transport bag about a vertical axis makes it possible to have the part open to the side face towards the back, front, right, left, or any desired direction.

In the loading position, i.e. the position in which one wall element of the rear wall is oriented horizontally, while the other wall element of the rear wall is oriented vertically, the bag can preferably also be unloaded. If, in this position, the coupling mechanism is actuated and as a result the front wall is disengaged from the rear wall in the lower region, the two walls swing apart from one another. The resulting opening, from which goods can now fall out of the transport bag, is therefore larger than for the case in which both wall elements of the rear wall are oriented vertically. In the latter case, a situation can occur in which, although the front wall and rear wall are disengaged from one another, they nonetheless hang down vertically at a small spacing from one another. In particular small and/or lightweight objects could jam between the front wall and rear wall. If, in contrast, the transport bag is opened in the loading position, small and/or lightweight objects can also reliably leave the transport bag.

Preferably, the two wall elements of the rear wall along an outside edge of the rear wall are dimensionally stable and can be tilted relative to one another about a joint axis.

The dimensional stability of the outside edge of the wall elements makes it possible to transmit a force via the outside edge. Thus, for example, a force can be applied to each of the two wall elements, in order to tilt these relative to one another about their joint axis. It is conceivable, for example, that a force, acting on one of the wall elements, can be used to bring the other wall element for example from a vertical into a horizontal position. The dimensionally stable outside edge can furthermore absorb a force which is required for actuating the coupling mechanism. Furthermore, a dimensionally stable outside edge provides better protection against impacts and damage, for goods received in the transport bag, than in the case of a flexible transport bag.

In this case, two wall elements are preferably an upper wall element and a lower wall element. In this case, the upper wall element comprises a first C-shaped frame and a frame part provided centrally on the first C-shaped frame. On a frame part of this kind, the transport bag can be easily gripped by a gripping device in an overhead conveyor system, in order to bring said bag into the loading position. Further preferably, the frame part is attached to the first C-shaped frame so as to be pivotable about a second joint axis that extends substantially in parallel with the joint axis. In the case of a transport bag of this kind, it is not necessary for the overhead conveyor system to comprise rotatable components in order to bring the transport bag into the loading position after the frame part has been gripped by the gripping device.

Preferably, one of the two wall elements of the transport bag comprises a planar, in particular dimensionally stable, material.

A planar wall element makes it possible for the transport bag to be designed in a torsion-resistant manner, which is particularly easily possible using a dimensionally stable material. It is therefore possible to prevent the transport bag from wrinkling. As a result, the transport bag can be moved in a particularly compact manner in the overhead conveyor system and can be stored, in particular in the empty state. A dimensionally stable, planar rear wall furthermore allows for simple attachment of the coupling mechanism. A rear wall of this kind even offers still better protection of the transported goods against damage. The planar rear wall can be designed such that it simultaneously serves as a sliding surface. For example, the transport bag can be moved in a sliding manner over the rear wall, over a slide, or the rear wall can itself be used, during loading and unloading, as a slide for sliding goods into the transport bag or for sliding out goods located therein.

The suspension device of the transport bag is preferably immovably connected to the rear wall and is in particular designed as a U-shaped hook.

Since the suspension device is immovably connected to the rear wall, for example a rotational and/or tilting movement of the suspension device can be transmitted directly to the transport bag. A U-shaped hook is a particularly simple and cost-effective means for implementing a suspension device of this kind.

Preferably the coupling mechanism comprises at least one receiving space, preferably two receiving spaces, and a pawl, preferably two pawls, on the rear wall. In this case the receiving space is designed to receive a closure element of the front wall in such a way that it is held in the receiving space by the pawl. In this case, the coupling mechanism comprises a release mechanism, by means of which the pawl can be disengaged in order to release the closure element.

In this case, “pawl” means a device which is actuated and allows the reception simply by the movement of the closure element into the receiving space, but which cannot readily be opened again, in particular not without an action of force on the release mechanism. In an embodiment comprising two pawls, the release mechanism can be designed such that it releases only one of the pawls or alternatively both pawls.

In the case of this design of the coupling mechanism, the connection of the front wall to the rear wall and the disengagement thereof can be performed easily. In the case of an embodiment comprising two pawls, in which the release mechanism releases just one of the two pawls, it is possible for the transport bag to open initially only on the side on which the pawl was released, and the closure element of the front wall can slide out of the first receiving space. Transported goods then begin to slide out of the transport bag through the opening that widens first on this side. As soon as the front wall and rear wall are disengaged on this side, the closure element can be released from the second receiving space for example by sliding out laterally, without the second pawl having to be released for this purpose. This therefore makes it possible to open the transport bag in such a way that the goods fall out less abruptly than if the transport bag were opened on both sides simultaneously.

In the case of an embodiment of the transport bag comprising a pawl, the release mechanism preferably comprises a slider, in particular a rod guided along the rear wall, by means of which the pawl is movable for releasing the closure element.

A slider for actuating the release mechanism of the coupling mechanism makes it possible to bring about the release outside of the lower region of the transport bag, where the coupling mechanism is arranged. Thus, for example, the slider can be guided along the rear wall, in particular along the outside edge, from the lower region to an upper region of the transport bag, where a free end of the slider is then exposed, for actuating the release mechanism.

Alternatively to the slider of the release mechanism or in combination therewith, an actuation lever can be provided on the pawl, as the release mechanism. In this case, the actuation lever preferably extends to one side of the transport bag, i.e. a free end of the actuation lever faces to a right-hand or left-hand side of the transport bag when this is viewed from the front (or rear) looking towards the front wall (or rear wall). The pawl and the actuation lever are preferably formed in one piece. An actuation lever of this kind can be actuated by an external actuation device of an overhead conveyor system, for example a roller, which travels over the actuation lever when the transport bag is conveyed via the overhead conveyor system. As a result, the pawl is disengaged, and the closure element released.

Preferably, in the case of an embodiment of the transport bag comprising a receiving space, said receiving space is designed for receiving and releasing the closure element of the front wall from the front.

“From the front” means, in this connection, from a side which faces the front wall. In other words, this means that the closure element can move towards the rear, into the receiving space, relative to the receiving space. For example, the receiving space can be stationary, and the closure element can move into the receiving space towards the rear, counter to the conveying direction, in order to connect the front wall to the rear wall. It is also conceivable for the closure element to be stationary and for the receiving space to move forwards, in the conveying direction, towards the closure element. However, a further possibility is for neither the closure element nor the receiving space to be stationary, but rather that both move towards one another, viewed in relative terms.

As a result of the design of the receiving space for receiving and releasing from the front, the front wall and the rear wall can be easily coupled together and disengaged from one another in the lower region, in ongoing operation of the overhead conveyor system. It is then in particular possible to avoid having to perform a vertical movement with the front wall or the rear wall or both, in order to move the closure element into the receiving space.

Preferably, in the case of an embodiment of the bag comprising a receiving space, said receiving space is delimited by the pawl and an edge of the rear wall opposite the pawl.

Since the receiving space is delimited by the pawl and an edge of the rear wall opposite the pawl, a secure seating of the closure element in the receiving space can be ensured with simple means, which prevents unintended disengagement of the front wall from the rear wall.

According to a further aspect of the present invention, a support hook is provided for supporting a transport bag of an overhead conveyor system, which comprises a U-shaped hook as a suspension device. In this case, the support hook comprises an immovable bearing element having a contact surface for suspending and mounting the suspension device. The contact surface is delimited by a curved contour which allows for an upright rotation of the suspension device out of a basic orientation about a vertical axis extending through the contact surface, about a quarter circle, and in the process simultaneously brings about a continuous movement of the suspension device along the vertical axis, such that the suspension device pushes in the basic orientation due to gravity.

In this connection “quarter circle” means a rotation about approximately 90° about the vertical axis. However, deviating from this, the rotation can also be slightly, preferably no more than 10°, smaller or larger.

The design of the contour of the contact surface according to the claims makes it possible to ensure, by means of one support hook, two defined orientations of a transport bag that is suspended in the support hook with a U-shaped hook as the suspension device. In this case, the contour is formed such that, in a basic position, the U-shaped hook is suspended in the contact surface in a stable location, in which surface it remains on account of gravity and from which it cannot be removed without further action of force from the outside. The contour is furthermore shaped such that a rotation of the hook, on account of further action of force, simultaneously causes a movement against gravity into a second location, which can be defined by the contour, for example by a stop, and continues to be assumed only under ongoing action of force. Without this action of force, the hook strives to return to the basic position again, with a back-rotation. Thus, in order to be able to switch the hook, and thus the transport bag suspended thereon, between the two positions, in addition to gravity only the action of a further force in one direction, or the removal thereof, is required. Thus, in particular, no force reversal is required in order to bring about a back-rotation. It is thus particularly easily possible to rotate a transport bag, conveyed by means of the support hook, in an overhead conveyor system, as required, in order to orient this for filling for example from a loading station arranged to the right or to the left of the conveying direction. Due to the omission of movable bearing parts in the support hook, this is furthermore particularly low-maintenance, less prone to faults, and easy to produce.

Preferably, the support hook is designed for supporting the transport bag according to the aspect of the invention described above.

Preferably, the bearing element of the support hook allows for oscillation of the suspension device about all the axes lying in a horizontal plane.

The fact that the bearing element allows for oscillation of the suspension device about all the axes lying in a horizontal plane, i.e. there is no rigid fastening, makes it possible to ensure that the transport bag can always assume a vertical position, on account of gravity. Thus, a torque which can otherwise occur on the support hook by deflection of the transport bag can be prevented, which protects the support hook from overloading and damage. At the same time, acceleration forces which act on the transport bag for example due to starting up or stopping the overhead conveyor system, can be converted into an oscillation of the transport bag about the bearing element, and the corresponding torques do not, as would otherwise be necessary for rigid mounting, have to be absorbed by the bearing element.

Preferably, the contour limits the rotation of the suspension device about the vertical axis to a quarter circle.

As a result, an “over-rotation” of the suspension device about more than approximately 90° can be prevented. Thus, the orientation of a transport bag supported by the support hook can be easily and reliably switched between the basic orientation and an orientation that is rotated relative thereto in the quarter circle.

Preferably, at least two opposing sides of the support hook have outer contours comprising projections and corresponding recesses, which allows for an interleaved arrangement of neighboring support hooks.

The purposefully compensating arrangement of the recesses and projections makes it possible for the space assumed by a plurality of support hooks arranged one behind the other in the overhead conveyor system to be reduced. This is advantageous in particular if the support hooks are mounted in the overhead conveyor system without a transport bag. Furthermore, the compensating arrangement of the recesses and projections offers the advantage that a bundle consisting of support hooks arranged in an interleaved manner can be moved in a very stable manner and thus more reliably and more easily.

According to a further aspect of the present invention, a transport device for an overhead conveyor system is provided, the transport device comprising a transport bag according to the aspect described above, and a support hook.

The transport bag can be integrated into the overhead conveyor system via the support hook.

In this case, the support hook is preferably designed according to the aspect described above.

In the case of such a preferred embodiment of the transport device, the filling opening of the transport bag can be rotated particularly easily, in order, for example, to supply goods to it from a loading station arranged to the side of the overhead conveyor system.

According to a further aspect of the present invention, an overhead conveyor system is provided which comprises a plurality of the transport devices described above and a rail for conveying the transport devices, the transport devices being suspended on the rail during conveying, by the support hook. In this case, the overhead conveyor system comprises a loading station at which the rail is interrupted between a rail end and a rail start. The transport devices can in each case be conveyed by support arms, in the loading station, from the rail end to the rail start, and a loading device for loading the transport bag is arranged between the rail end and the rail start.

Since the rail is interrupted in the loading station, but the transport bags can be conveyed by support arms instead of the rail, it is possible to move the transport bags through the loading station, and in the process to fill them, in ongoing operation of the overhead conveyor system, i.e. without interruption of the conveying movement. Omitting the rail, on which the transport devices are suspended, which thus extends above the transport bags, in the region of the loading station makes it possible to allow goods to fall into the transport bags from above, without being impeded by the rail. For this purpose, the loading device, e.g. in the form of a ramp, can be oriented centrally with respect to the transport bags. The claimed overhead conveyor system is therefore particularly suitable for automatic loading.

However, the use of the transport bags according to the invention also makes it possible to bring these into the loading station in the loading position described above, which results in a gap between the front wall and rear wall. As is known from the prior art, the transport bag can then additionally continue to be loaded with goods through the side gap of the transport bag, for example manually, e.g. by an employee located on one side of the loading station.

The support arms preferably each comprise a gripping device for gripping the support hook and/or the suspension device and/or the rear wall.

A gripping device allows for reliable transfer of the transport bags from the rail into the loading station and vice versa. A gripping device can thus serve, for example for already grasping the support hook and/or the suspension device and/or the rear wall of the transport bag while this is still located on the rails. A gripping device can for example also be used for taking away the freedom of movement of the transport bag with respect to the support hook, on account of its suspension device. A transport bag grasped by a gripping device of this kind can be more easily rotated or tilted.

Preferably, each of the support arms comprises a pivot mechanism by which one of the wall elements of the rear wall of the respective transport bag can be pivoted, in order to bring the transport bag into a loading position.

This makes it possible, in the case of the transport device that is supported by a support arm, to switch said transport device between a transport position, in which both the wall elements assume a vertical position, and a loading position, in which one wall element assumes a horizontal position and the other wall element assumes a vertical position. Thus, in a loading position of this kind the filling opening is oriented upwards and to a side of the transport bags, which allows for filling from above and from the side and simplifies the filling overall. The pivot mechanism preferably comprises a joint, to which the gripping device is fastened, and which makes it possible, in particular, to tilt the gripping device about an axis in parallel with the longitudinal axis of the support arm. Further preferably, the transport bag can be brought into the loading position actively, in particular using a drive, by means of the pivot mechanism. In this case, the drive can be electrical and/or mechanical.

The overhead conveyor system, which comprises support arms having a pivot mechanism, preferably further comprises at least one guide rail for bringing the transport bag into a loading position, the at least one guide rail being arranged such that, during conveying of the transport devices, just one of the two wall elements slides along the guide rail.

A guide rail of this kind can take all or some of the weight of the transport bag, and thus relieves the support arm. Since just one of the two wall elements slides along the guide rail, the guide rail serves to tilt the two wall elements relative to one another, making use of gravity.

According to a further aspect of the present invention, an overhead conveyor system is provided, which comprises a plurality of the transport devices described above, which comprise a support hook according to the aspect described above, and a rail for conveying the transport devices, the transport devices being suspended on the rail during conveying, by the support hook. In this case, the overhead conveyor system comprises a loading station for loading one of the transport devices in each case. The loading station comprises a device for rotating the transport bag about the vertical axis about a quarter circle and for relative pivoting of the wall elements, connected to one another in a pivotable manner, relative to one another, in order to set the filling opening for lateral loading in the loading station.

In the case of an overhead conveyor system of this type, the loading station can be arranged to the side of the rail. This can be advantageous for example if an arrangement above the rail, which supports the transport devices, is not possible, for example due to a lack of space. Allowing lateral loading of the transport bag means that the loading can take place from a lower position than in the case of loading exclusively from above. The loading station can thus be arranged lower, which makes the overhead conveyor system more space-saving. The overhead conveyor system, in which the transport bags can be rotated about the vertical axis for loading, can, however, also be combined with the overhead conveyor system described further above, arranged upstream or downstream in the conveying direction.

The rail is preferably formed continuously through the loading station.

As a result, a relocation of the transport devices to another conveying element in the region of the loading station, e.g. to support arms which take over the conveying, can be avoided.

The loading device of the overhead conveyor systems according to the aspects described above preferably comprises a ramp, a conveyor belt, or a slide.

This allows for filling of the transport bags using simple means, in the case of a ramp or slide in particular only using gravity. In this case, the packaging of the goods, with which respective goods located in the loading station are intended to be loaded, can take place at a different location from the loading station. The goods can be moved from the site where they are packaged to the loading station by the ramp, conveyor belt or slide.

Further advantages and developments of the invention emerge from the following description of the figures and all of the claims. The features set out individually in the claims can be combined with one another in any desired, technologically meaningful, manner, and can be supplemented by illustrative substantive matter from the description, further embodiments of the invention being shown.

### BRIEF DESCRIPTION OF THE FIGURES

FIG. 1 is a perspective rear view of an empty transport device in a closed transport position.

FIG. 2 is a perspective front view of a further embodiment of a transport device in the open state.

FIG. 3 is a perspective rear view of the transport device from FIG. 1 in a loading position.

FIG. 4 is a perspective view from below of the transport device from FIG. 3 in the open state.

FIG. 5 is an enlarged view of the coupling mechanism of the transport device from FIG. 4.

FIG. 6a is a semi-transparent isometric view of the closures of the transport device from FIG. 3.

FIG. 6b is an enlarged perspective view of a closure comprising a slider for disengaging the pawl.

FIG. 6c shows the closure from FIG. 6b having a cover placed thereon.

FIG. 6d is an enlarged perspective view of a closure comprising an actuation lever provided on the pawl for disengaging the pawl.

FIG. 6e shows the closure from FIG. 6d having a cover placed thereon which comprises a recess through which the actuation lever protrudes towards the outside.

FIG. 7 shows a further variant of a coupling mechanism, in which the pawls can be moved downwards for release.

FIG. 8 shows a coupling mechanism in which the pawls can be moved upwards for release.

FIG. 9 is a perspective view of a support hook for supporting a transport bag.

FIG. 10 is a detail view of the support hook from FIG. 9 comprising a suspended transport bag.

FIG. 11 shows a plurality of support hooks arranged in an interleaved manner.

FIG. 12 shows an overhead conveyor system, in which the transport devices are conveyed by support arms through a loading station.

FIG. 13 shows the gripping process by means of a gripping device which is provided for the support arms of the overhead conveyor system shown in FIG. 12.

FIG. 14a shows a frame construction of a transport bag, in which the first C-shaped frame comprises a rotatably mounted frame part.

FIG. 14b shows the frame construction from FIG. 14a in a loading position of the transport bag.

FIG. 15 shows an overhead conveyor system, in which the transport devices are rotated for filling by means of a loading device from the side.

FIG. 16 shows how the rotation process of the transport device is carried out by means of a stop, for the overhead conveyor system from FIG. 15.

### WAYS OF IMPLEMENTING THE INVENTION

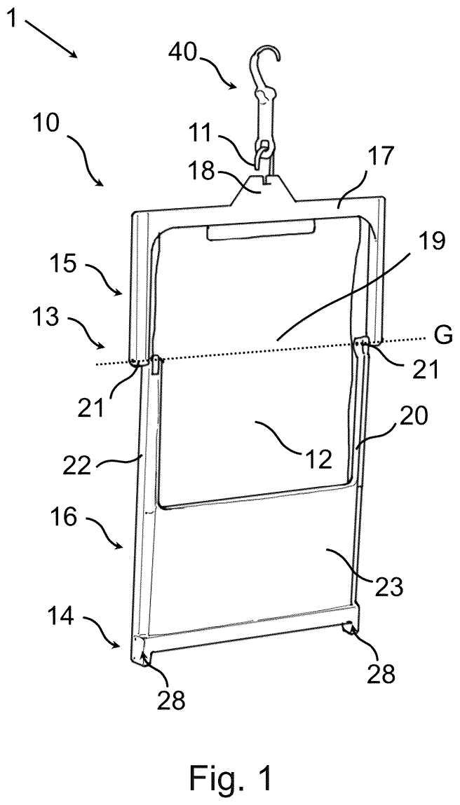

FIG. 1 is a perspective rear view of an empty transport device 1 according to the present invention. The transport device 1 is in a closed transport position. The transport device 1 comprises a transport bag 10 and a support hook 40 which supports the transport bag 10. The transport bag 10 comprises a U-shaped hook as a suspension device 11, by means of which it hangs on the support hook 40.

Furthermore, the transport bag 10 comprises a front wall 12 and a rear wall 13, which are in each case connected to one another in the upper and lower region. The rear wall 13 comprises a coupling mechanism 14, which will be discussed in further detail below. The rear wall 13 is formed of two wall elements 15, 16. The upper wall element 15 comprises substantially just one first C-shaped frame 17 as part of the outside edge 22 of the rear wall. In this case, the central part of the first C-shaped frame 17 forms the upper edge of the transport bag 10. A trapezoidal frame part 18 in the center of the first C-shaped frame 17 serves for fastening the suspension device 11. The first C-shaped frame 17 encompasses the upper part of the filling opening 19 of the transport bag 10.

The lower wall element 16 comprises a second C-shaped frame 20 which, together with the first C-shaped frame 17, forms the outside edge 22 of the rear wall 13. The two free ends of the first C-shaped frame 17 are coupled to the free ends of the second C-shaped frame 20 via joints 21. The joints 21 make it possible to tilt the lower wall element 16 relative to the upper wall element 15, about a common joint axis G. In this case, the lower wall element 16 is guided inside the upper wall element 15. In the transport position, the wall elements 15, 16 hang almost vertically downwards.

The lower wall element 16 further comprises a support wall 23 for supporting the transported goods, which wall extends between the second C-shaped frame 20. However, in this case the support wall 23 covers only a part of the surface that is spanned by the second C-shaped frame 20. An upper surface of the lower wall element 16 remains free, and this free surface, together with the surface spanned by the first C-shaped frame 17, forms the filling opening 19 of the transport bag 10.

In the lower region of the lower wall element 16, in each case a closure 28 is provided on both sides, as part of the coupling mechanism 14 which is described in greater detail below.

In the embodiment shown in FIG. 1, the two wall elements 15, 16 are made of a dimensionally stable plastics material. However, embodiments are also conceivable in which the wall elements 15, 16 comprise metal. It is also conceivable for the wall elements 15, 16 to comprise flexible materials. For example, the support wall 23 can be produced from a material which is preferably planar, a net-like material being less preferred but not excluded.

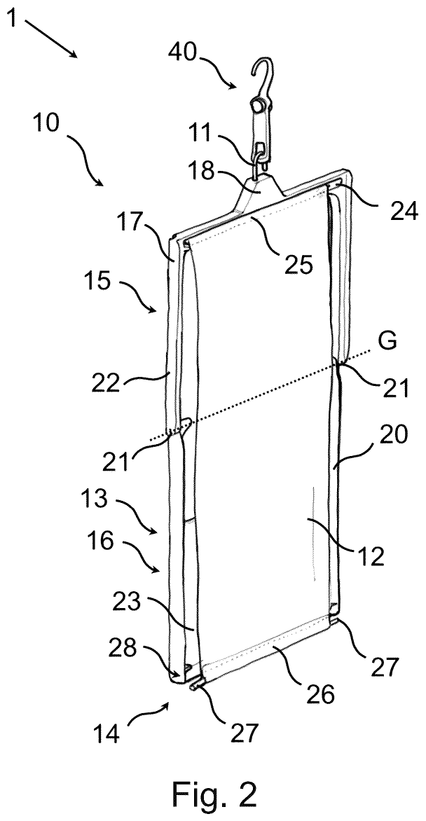

FIG. 2 is a perspective front view of a further embodiment of a transport device 1 in the open state, which is also in a transport position. The same and corresponding elements of the transport device 1 from FIG. 2 and those from one of the remaining figures may be denoted by the same reference numbers. In this embodiment, the front wall 12 is produced from a flexible material and covers substantially the entire rear wall 13 of the transport bag 10. In the embodiment described, the front wall 12 and rear wall 13 are connected to one another at their upper sides in such a way that they can be pivoted relative to one another. For this purpose, the front wall 12 comprises a horizontal pin 24 on its upper side, which pin extends through a first seam 25 of the front wall 12. The horizontal pin 24 is mounted at its two ends in the first C-shaped frame 17 of the rear wall 13. On the underside, the front wall 12 comprises a second seam 26, through which the closure element 27 extends. In the embodiment described, the closure element 27 is also a pin.

In the transport position shown in FIG. 2, the closure element 27 is not received in the closures 28, such that the front wall 12 and the rear wall 13 are separated from one another in the lower region. Irrespective thereof, however, it is clearly visible that, in an empty state of the transport bag 10, the front wall 12 and rear wall 13 are close together. Although this makes it possible to store or transport the empty transport device 1 in a space-saving manner in the suspended state, loading of the transport bag 10 through the filling opening 19 in this state is possible only to a limited extent, because goods introduced through the filling opening 19 would first have to push the front wall 12 away from the rear wall 13. For loading the transport bag 10, it is provided to tilt the wall elements 15, 16 relative to one another, as is explained below.

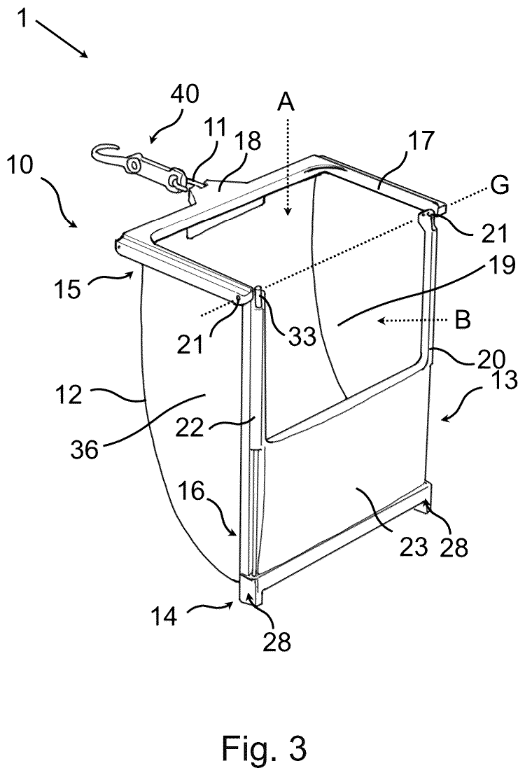

FIG. 3 is a perspective rear view of the transport device 1 from FIG. 1 in a loading position in which the transport bag 10 is ready to receive goods. In this case, the upper wall element 15 is tilted relative to the wall element 16 by approximately 90° about the joint axis G, such that it is in the horizontal. The tilting means that a filling volume forms in the transport bag 10. At the same time, only the upper part of the filling opening 19 faces upwards, while the lower part is still oriented towards the side, such that goods can be easily introduced through the filling opening 19 both from above, as indicated by the arrow A, and from the side, as indicated by the arrow B. Furthermore, a side opening 36 results in the loading position, between the front wall 12 and the rear wall 13, which opening can likewise be used for loading from the left-hand and/or right-hand side, with respect to the rear wall 13.

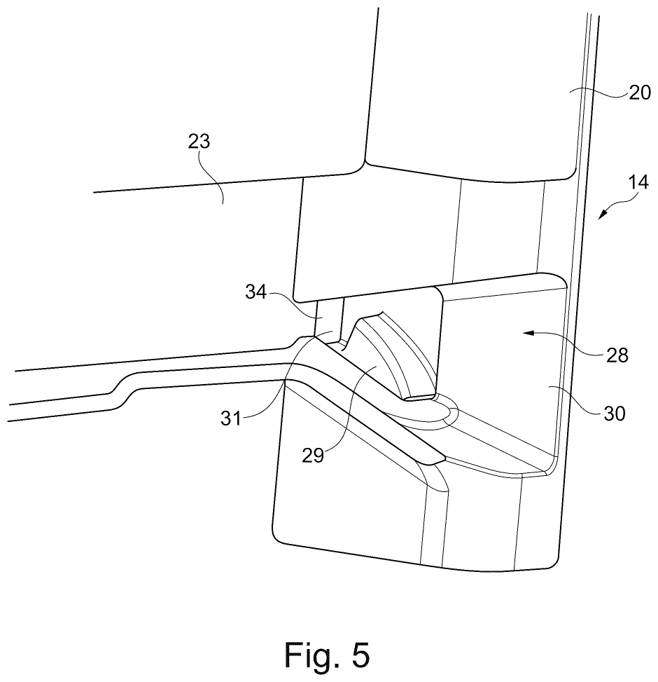

On the right-hand side of the rear wall 13, a slider 33 extends vertically along the outside edge 22 as a part of a release mechanism, which slider, in the embodiment described in FIG. 3, is a rod that is guided in part in the second C-shaped frame 20, for releasing the closure element 27 (not shown in FIG. 3) from the closure 28. The slider 33 has a free end in the region of the joint 21. In the loading position, the free end of the slider 33 is particularly easily accessible, in order to be actively actuated by an actuator for example. However, it is also conceivable for the transport device 1 to move through under a roller, in the loading position, which roller moves over the free end of the slider 33 and thus actuates it. The force applied to the free end of the slider 33 is transmitted via the slider 33 to the other end thereof for moving a pawl 29 (not shown in FIG. 3), which is described in greater detail with respect to FIG. 5. Embodiments of the present invention are also conceivable where the release mechanism does not comprise any slider 33 for disengaging the pawl 29, but rather is for example an electromechanical actuator, which is actuated via a control signal.

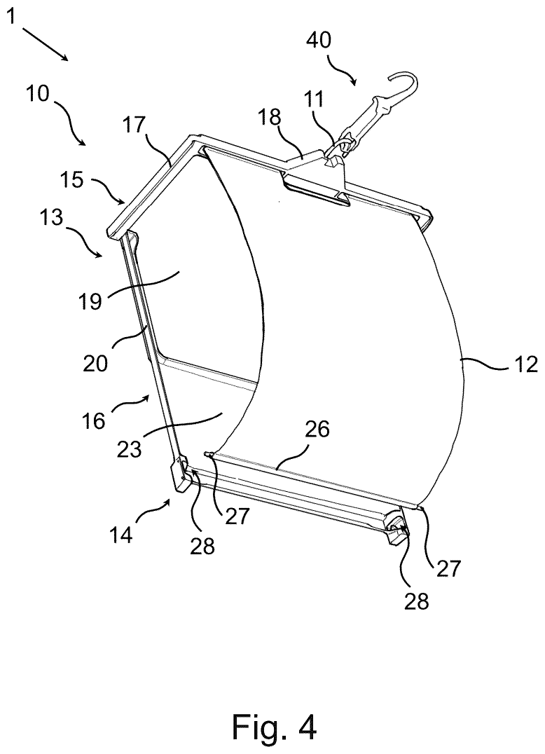

FIG. 4 is a perspective view from below of the transport device 1 from FIG. 3 in the open state. The closure element 27 is released from the closures 28 on both sides. For unloading the transport bag 10, this is preferably in the tilted position shown in FIG. 4. As a result, the released front wall 12 swings away from the rear wall 13 and transported goods fall downwards through the resulting opening and out of the transport bag 10.

FIG. 5 is an enlarged view of a closure 28 of the coupling mechanism 14 of the transport device 1 from FIG. 4. The closure 28 comprises a funnel-shaped opening 30 which tapers in the direction of the rear wall 13. The funnel-shaped opening 30 simplifies the insertion of the closure element 27 into the closure 28. In the embodiment described in FIG. 5, the pawl 29 is designed in the form of a spring-loaded catch, which rises from the underside of the funnel-shaped opening 30, starting like a ramp, in the direction of the support wall 23, but does not reach quite to the support wall 23. A receiving space 31 is formed between an edge of the rear wall 34 and a rear end of the pawl 29, in which receiving space there is space for the closure element 27 (not shown in FIG. 5). For closing the transport bag 10, the closure element 27 is guided towards the rear in the funnel-shaped opening 30. In this case, it slides over the pawl 29, i.e. the spring-loaded catch, which is thereby pushed downwards and releases the receiving space 31 towards the front. As soon as the closure element 27 has passed the spring-loaded catch, this is pushed upwards again by the spring force, and the receiving space 31 is automatically closed. The closure element 27 is therefore blocked between the pawl 29 and the edge of the rear wall 34, and secured against disengagement. By means of the slider 33 (not shown in FIG. 5), the spring-loaded catch can be pushed downwards, as a result of which the closure element 27 is released from and can be moved out of the receiving space.

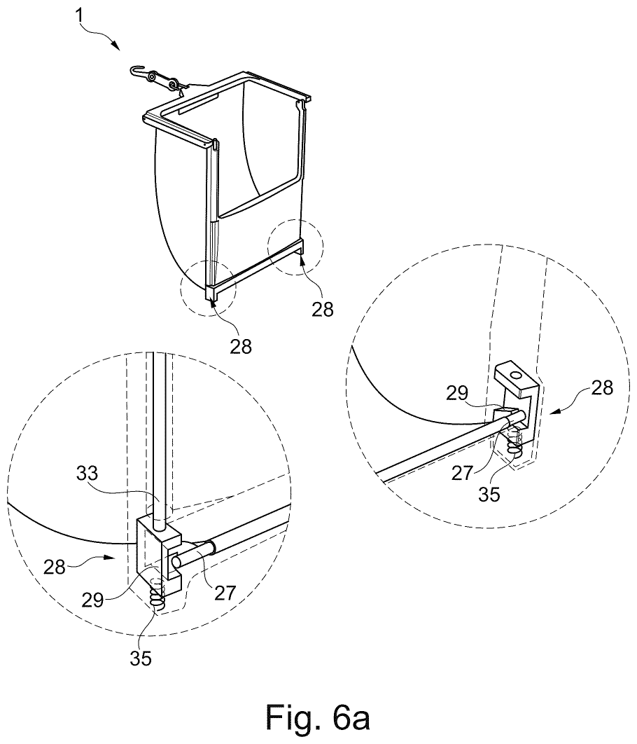

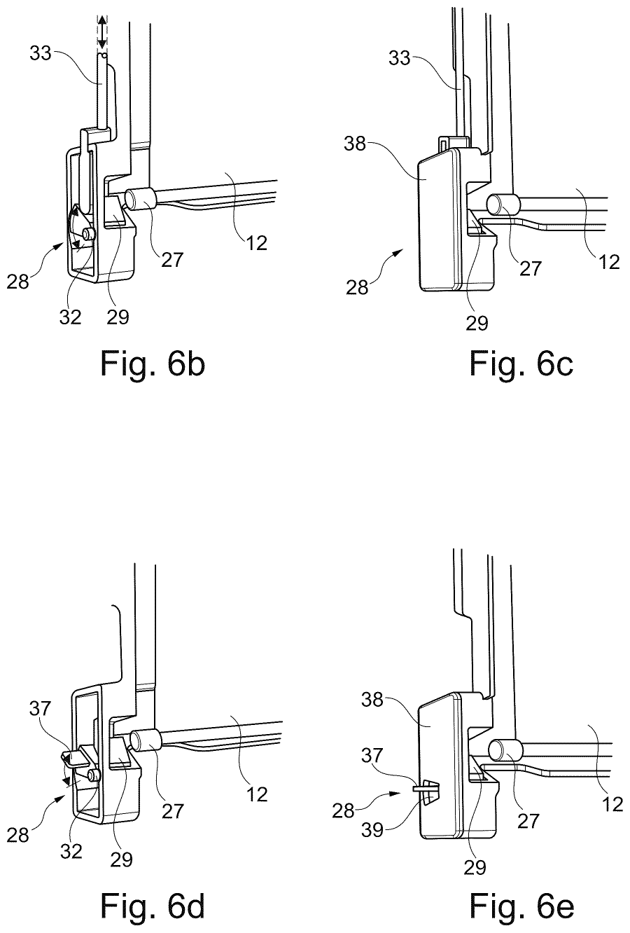

The mode of operation of the closure 28 is again clear in FIG. 6a, which shows the closures 28 of the transport device 1 from FIG. 3 in an enlarged, semi-transparent, isometric view from behind. The pawl 29 is mounted on a spring 35. The pressure of the slider 33 on the pawl 29 makes it possible for said pawl to be moved downwards, counter to the spring force of the spring 35, as a result of which the closure element 27 is unlocked. In the embodiment shown in FIG. 6a, the slider acts only on the left-hand pawl 29. However, other embodiments are also conceivable in which the slider 33 can unblock the other pawl 29 via a linkage, or a second slider is provided for the other pawl.

FIG. 6b is an enlarged perspective view of a closure 28 comprising a slider 33 for disengaging the pawl 29. An end portion of the slider 33 is designed such that it comes to rest on a part of the pawl 29 upon actuation of the slider 33. In the example shown, the pawl 29 is mounted so as to oscillate about a pawl axis 32 and can be reset by means of a spring (not shown). If the slider 33 is now displaced further, the pawl 29 oscillates counter to the restoring direction or restoring force of the spring about the pawl axis 32 and dips away downwards, such that the closure element 27 can leave the closure 28 unimpeded.

FIG. 6c shows the closure 28 from FIG. 6b having a cover 38 placed thereon, which protects the internal mechanism of the closure 28 from damage.

FIG. 6d is an enlarged perspective view of another closure 28 in which an actuation lever 37 for disengaging the pawl 29 is provided on the pawl 29. In the example shown, the pawl 29 and the actuation lever 37 are formed in one piece, which, however, is generally not essential. The actuation lever 37 protrudes on one side of the transport bag 10 when this is viewed looking at the front wall 12 (or rear wall). It therefore constitutes the part of the closure 28 that protrudes laterally to the greatest extent. The actuation lever 37 serves for being actuated by an actuation means (not shown) during conveying of the transport bag 10 in an overhead conveyor system. Preferably, the actuation device is a roller which travels over the actuation lever 37. In the same way as in the case of the closure 28 shown in FIG. 6b and FIG. 6c, the pawl 29 is pivoted about the pawl axis 32 for disengaging the closure element 27.

FIG. 6e shows the closure from FIG. 6d having a cover 38 placed thereon which comprises a recess 39 through which the actuation lever 37 protrudes towards the outside. The recess 39 is formed such that the actuation lever 37 can move unimpeded therein at least to such an extent that the pawl 29 can be pivoted sufficiently for disengaging the closure element 27.

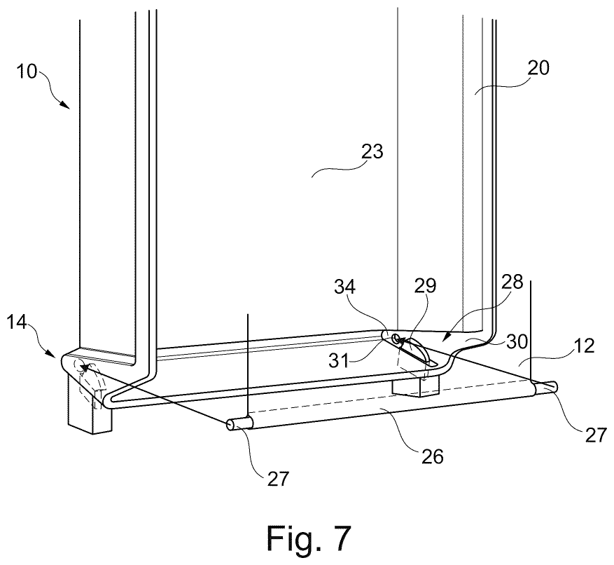

FIG. 7 is a detailed view of a further variant of a coupling mechanism 14 of a further transport bag 10. In the drawing, the front wall 12 of the transport bag is only indicated. The closure process of the transport bag 10 by the closure element 27 being received along the funnel-shaped openings 30 into the receiving spaces 31 from the front is indicated by arrows in FIG. 7.

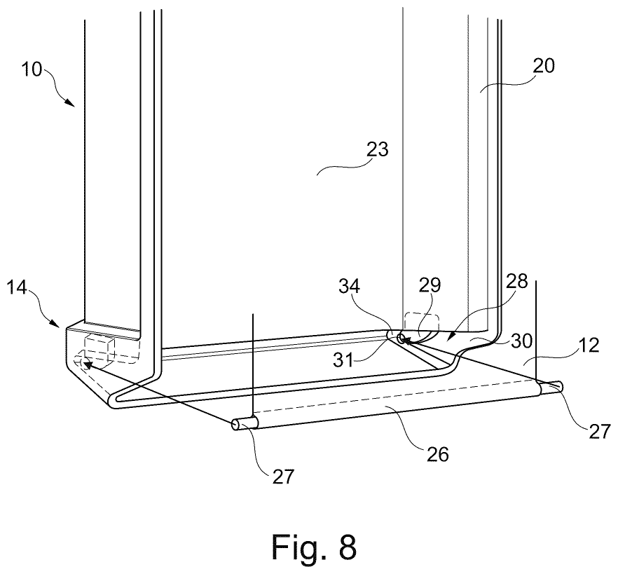

FIG. 8 shows a coupling mechanism 14 of a further transport bag 10 in which the pawls 29 can be moved upwards for releasing the closure elements 27. In the case of such an embodiment of the transport bag 10, it is possible to design this so as to be more compact towards the bottom, because it is not necessary to provide space on the underside of the transport bag 10 for the pawls 29 to dip in.

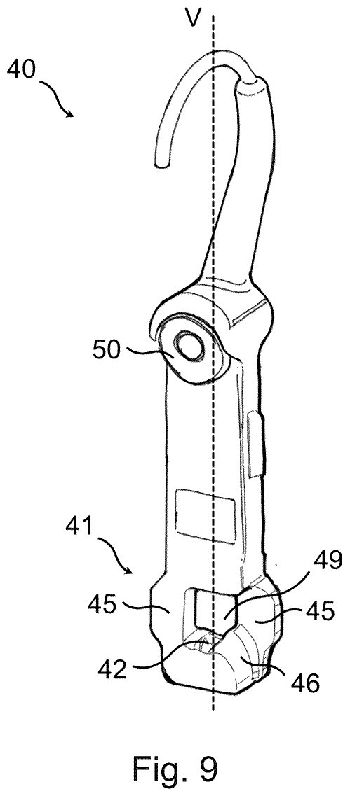

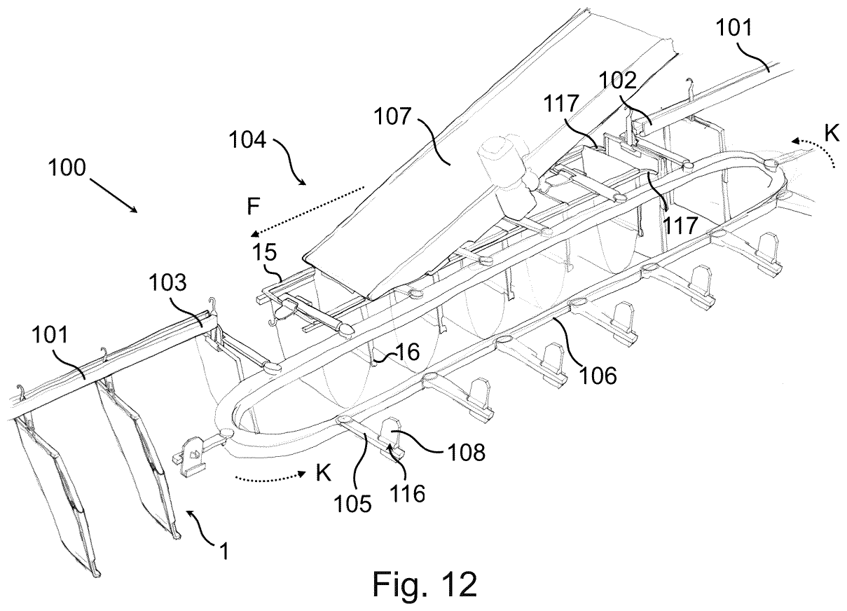

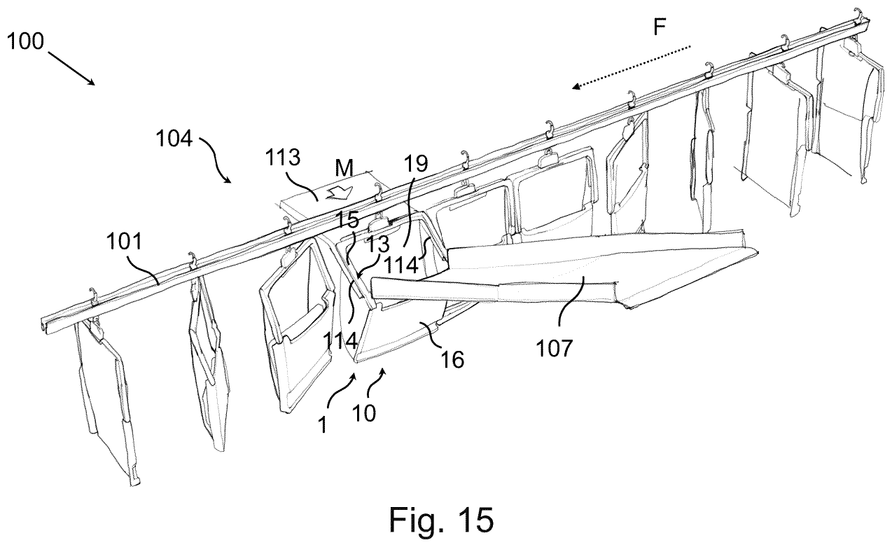

FIG. 9 is a perspective view of a support hook 40 for supporting a transport bag 10. In an upper region, the support hook 40 comprises a hook in order to thereby be integrated into an overhead conveyor system. Below this, the support hook 40 comprises a pair of rollers 50, with which it can slide over a rail (see e.g. rail 101 in FIG. 12 and FIG. 15) of the overhead conveyor system. In its lower region, the support hook 40 comprises a bearing element 41, in which the suspension device 11 in the form of a U-shaped hook of a transport bag 10 can be suspended. The support hook 40 extends substantially along a vertical axis V. The bearing element 41 comprises an opening 49 through which the U-shaped hook is introduced. Furthermore, the bearing element 41 comprises a contact surface 42 having a curved contour through which the vertical axis extends. The curved contour is shaped such that the contact surface 42 forms a horizontal well transversely to the vertical axis V, in which well the U-shaped hook of the transport bag 10 comes to rest in a basic orientation. Furthermore, the curved contour is shaped such that the U-shaped hook can be rotated about the vertical axis V and in the process moves in a sliding manner along the contact surface 42, upwards out of the well, in the direction of the vertical axis. The contact surface 42 is designed such that the U-shaped hook has assumed its highest position after a quarter-circle rotation. A rotation about more than 90° is prevented by the two bars 45. The curved contour of the contact surface 42 comprises two chamfered or rounded flanks 46, of which only one, in front of the right-hand bar 45, is visible in the perspective view shown in FIG. 9. The other chamfered flank 46 is arranged on the side of the bearing element 41 facing away from the view, behind the left-hand bar 45. The chamfered flanks 46 cause the U-shaped hook, without a force permanently holding it, to slide down again, driven by gravity alone, with a quarter-circle rotation in the other direction, from its highest position in order to assume its basic orientation in the well.

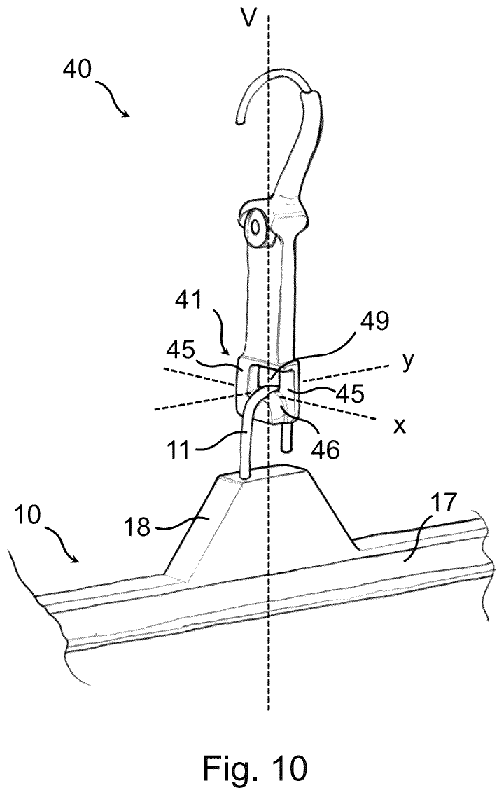

FIG. 10 is a detail view of the support hook 40 from FIG. 9 comprising a transport bag 10 suspended in the basic position. As described above, in this case the suspension device 11 in the form of the U-shaped hook sits in the well of the contact surface 42. The described shape of the bearing element 41 not only allows for the rotation of the suspension device 11 about the vertical axis V, but rather also oscillation around axes which are located in the horizontal plane, which is spanned by the x- and y-directions shown in FIG. 10.

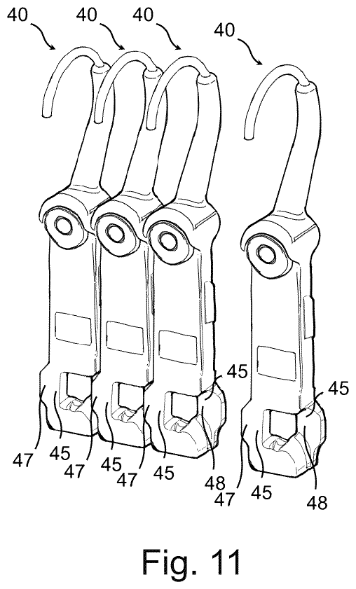

FIG. 11 shows a plurality of support hooks 40 arranged in an interleaved manner. In each case, a support hook 40 comprises a projection 47 and a recess 48 in each case, on its mutually opposing bars 45, which projections and recesses engage in the corresponding projections 47 and recesses 48 of the neighboring hook.

FIG. 12 shows an overhead conveyor system 100, in which the transport devices 1 are conveyed by support arms 105 through a loading station 104. The conveying direction of the support arms 105 in the loading station 104 is identified by the arrow F. The rail 101, on which the transport devices 1 are conveyed in a suspended manner, is interrupted in the region of the loading station 104 between a rail end 102 and a rail start 103. In this region, a racetrack-shaped carousel 106 is arranged, around which the support arms 105 run. The direction of rotation of the carousel 106 is identified by the arrows K. In order to convey the transport devices 1 through the loading station 104, these are received on the rail end 102 of the support arms 105 by means of the gripping device 108, as is described in greater detail below. The support arms 105 then extend together with the transport devices 1 supported thereby, along a straight line of the carousel 106.

In the region of the interrupted rail 101, a pair of horizontally extending guide rails 117 is provided, which is arranged under the support arms 105 and centrally with respect to the conveyed transport bags 10. By means of the guide rails 117, the transport bags 10 are brought into the loading position, as described below. The spacing of the two guide rails 117 is selected such that it corresponds approximately to the width of the upper wall element 15 of the transport bags 10, but is larger than the width of the lower wall element 16 of the transport bags 10. Therefore, upon entry of a transport bag 10, carried by a support arm 105, into the loading station, the upper wall element 15 of the transport bag 10 strikes against the guide rails 117, while the lower wall element 16 can move unimpeded between the two guide rails 117.

The support arms 105 comprise a pivot mechanism 116. In the embodiment shown, the pivot mechanism 116 is merely a joint, on which the gripping device 108 is rotatably mounted. However, embodiments are readily conceivable in which the entire support arm 105 is rotatably mounted about its longitudinal axis. The upper wall element 15 gripped by the gripping device 108 can be rotated into a horizontal position by the pivot mechanism 116. For this purpose, in the further course of conveying, the transport bag 10 is pulled from the support arm 105 over the guide rails 117, wherein the upper wall element 15 is set down in the horizontal position on the guide rails 117, under rotation. The guide rails 117 thus serve for the sliding transport of the transport bag 10 through the loading station 104 and support the majority of the weight of the transport bag 10. The lower wall element 16 which extends inside the upper wall element 15 and is tiltable relative thereto hangs vertically downwards inside the guide rails 117. The transport bag 10 that is brought into the loading position in this way is pulled from the support arm 105, in the further course of the conveying, under a loading device 107. Since no rail 101 is located in the region of the loading station 104, the transport bags 10 that are in the loading position and are open at the top can be loaded from above by the loading device 107, in the embodiment shown a conveyor belt. Preferably, the conveying speeds of the carousel 106 and of the conveyor belt are matched to one another. Embodiments are also conceivable in which the loading takes place via a ramp or slide, provided that the feed frequency thereof is matched to the frequency of the transport devices 1 traveling past. It is furthermore also conceivable for the loading to take place via a robot.

Furthermore, embodiments are also conceivable in which the pivot mechanism 116 comprises an active drive by means of which the transport bags 10 can be rotated into a loading position. In such an embodiment, the guide rails 117 can be omitted.

Since the guide rails 117 end before the rail start 103, the transport bags 10 oscillate by themselves, under the influence of gravity, back into a conveying position, in which the two wall elements 15, 16 are oriented substantially vertically, as soon as the upper wall element 15 has left the guide rails 117. Furthermore, in this case the support hook 40 is again oriented in such a way that it can be inserted into the rail 101. At the end of the straight line of the carousel 106, the transport devices 1 are placed from the support arms 105 onto the rail start 103, disengaged from the gripping device 108, and continue to pass through the overhead conveyor system 100 from there. The support arms 105 return, on the back straight of the carousel, to the rail end 102 for receiving approaching transport devices 1 again.

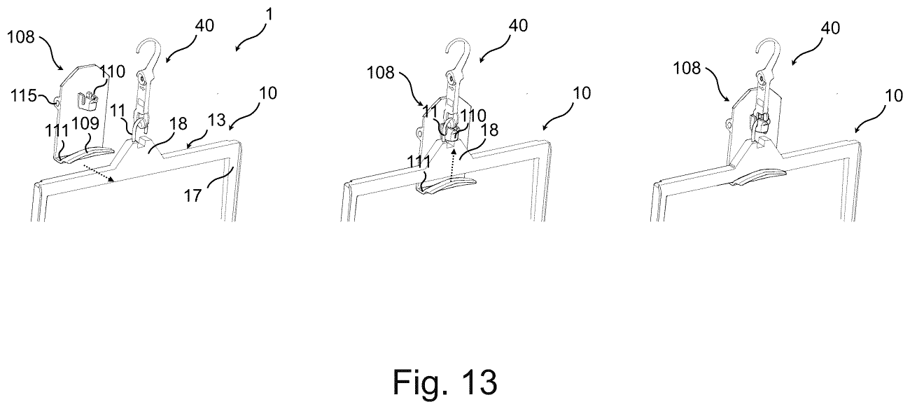

In order to remove the transport devices 1 from the rail 101 and to insert them therein, each support arm 105 comprises a gripping device 108. This gripping device 108 without the associated support arm 105 is shown in FIG. 13 for different stages of the gripping process. In order to illustrate the gripping process, furthermore only a detail of the rear wall 13 of the transport bag 10 without the front wall 12 fastened thereon is shown. The gripping device 108 has substantially a planar body, which comprises a joint receptacle 115 on its rear side for rotatable coupling to the joint of the pivot mechanism 116 of the support arms 105 from FIG. 12. Furthermore, the planar body comprises a lip 109 on its underside. A groove 111 is formed between the lip 109 and the body, the width of which groove is adjusted to the width of the first C-shaped frame 17 in the region of the trapezoidal frame part 18. Furthermore, the body comprises a gripping hook 110 in the center on its front side. Said hook is designed such that it can penetrate through an opening in the suspension device 11, by means of which the transport bag 10 is suspended in the support hook 40. Furthermore, the gripping hook is designed such that it forms a seat for the bearing element 41 of the support hook and the suspension device 11 of the transport bag 10. The gripping device 108 is moved closer to the rear wall 13 in such a way that the groove 111 is located under the trapezoidal frame part 18 of the rear wall 13. At the same time, in this case, the gripping hook 110 is pushed into the free opening of the U-shaped suspension device 11, such that it is located under the bearing element 41. Then, the gripping device 108 is moved vertically upwards, relative to the transport bag 10. For this purpose, for example the gripping device 108 can be actively moved towards the transport bag 10 and/or the transport bag 10 can be actively moved towards the gripping device 108. However, embodiments are also conceivable in which the transport bag 10 falls into the gripping device 108 in the same way, using only gravity. As a result, the trapezoidal frame part 18 comes to rest in the groove 111. In the process, the bearing element 41 and the suspension device 11 are placed into the gripping hook 110. By means of the described gripping device 108, the transport bag 10 is immobilized during the gripping process, i.e. a rotation of the suspension device 11 with respect to the bearing element 41 is prevented. This prevents a movement, rotation and/or pivoting of the support arm 105 resulting in an uncontrolled movement of the transport device 1. The disengagement of the gripping device 108 from the transport bag 10 takes place in the reverse sequence. Using the described gripping device 108, it is possible to grip the transport device 1 from the rear side or the front side. However, the latter requires the front wall 12 to comprise a recess in its upper region, as shown for example in FIG. 1, through which the gripping device 108 can grasp the rear wall 13.

As has been described above, in the case of the overhead conveyor system 100 from FIG. 12, the support arms 105 either comprise a pivot mechanism 116 and the associated gripping devices 108 comprise a joint receptacle 115 for rotatable coupling to the joint of the pivot mechanism 116, or are themselves rotatably mounted in order to be able to rotate the upper wall element 15, which is formed substantially of the first C-shaped frame 17 and the trapezoidal frame part 18 formed thereon in a rotationally fixed manner, into a horizontal position. However, a solution is also conceivable in which the trapezoidal frame part 18 is rotatably connected to the first C-shaped frame 17. Transport bags 10 which have a frame construction of this kind can be brought into the loading position without the loading station 104 having to have the above-mentioned features which ensure the rotation of the upper wall element 15. The rotatability of the upper wall element 15, although this has been grasped by a gripping device, is then made possible using means of the transport bag 10 itself. This is advantageous if the transport device 1 according to the invention is also intended to be used in existing overhead conveyor systems and loading stations located therein, which do not comprise any of the components shown in FIG. 12, such as the pivot mechanism 116 or the rotatably mounted support arms 105, because then the costs for converting the existing overhead conveyor systems are reduced.

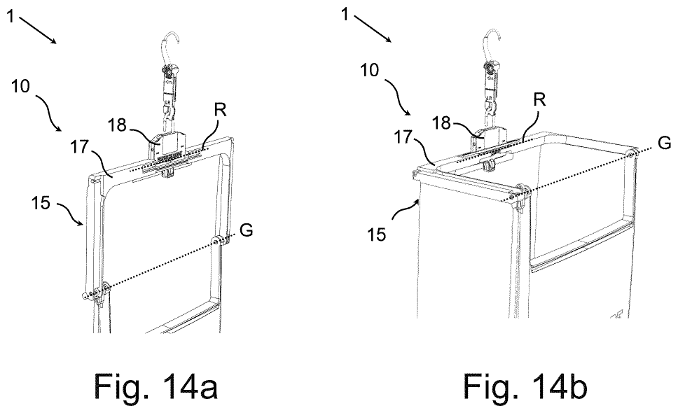

A transport device 1 having such a frame construction is shown in FIG. 14a. Unlike in the case of the transport devices 1 shown hitherto, the trapezoidal frame part 18 and the first C-shaped frame 17 are not formed integrally, i.e. not in a rotationally fixed manner, but rather the trapezoidal frame part 18 is connected to the first C-shaped frame part 17 via a second joint axis R. The second joint axis R extends substantially in parallel with the joint axis G of the transport bag 10. If a gripping device, such as the gripping device 108 shown in FIG. 13, engages in the rotatably mounted trapezoidal frame part 18, in order to remove the transport device 1 (as shown e.g. in FIG. 12) from a rail 101, the rotation of the upper wall element 15 required for opening the transport bag 10 can take place in that the first C-shaped frame rotates relative to the trapezoidal frame part 18.

The relative rotation of the first C-shaped frame 17 with respect to the trapezoidal frame part 18 in the loading position of the transport device 1 is shown in FIG. 14b.

Although in the embodiments of the transport bag 10 shown hitherto the frame part 18 has been referred to throughout as “trapezoidal”, it can also be of any other shape, in each embodiment, that is suitable for being gripped by a gripping device, in particular a rectangle shape or triangle shape. It is also possible to provide the frame part 18 so as to be flush with the first C-shaped frame 17 and not to stand out therefrom in terms of shape.

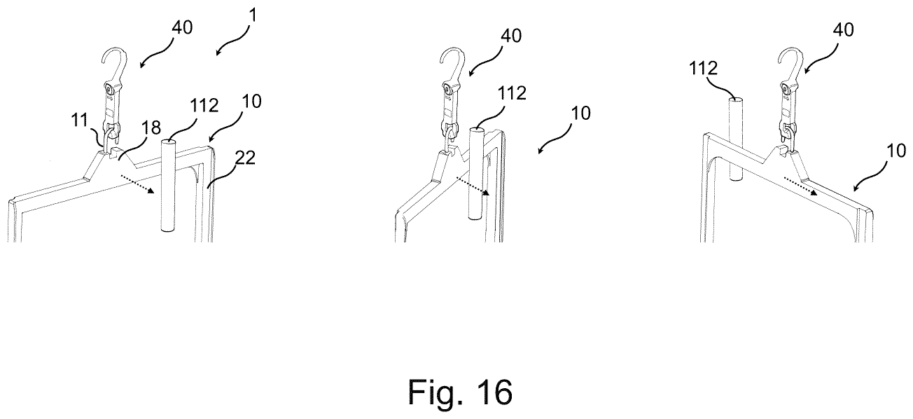

FIG. 15 shows an overhead conveyor system 100 in which the loading station 104 is designed for loading from the side. The conveying direction is again designated by an arrow F. In this embodiment, the overhead conveyor system 100 comprises a continuous rail 101. Upon entering the loading station, each transport device 1 is rotated laterally about 90° by means of a stop (not shown). This rotation process is explained in greater detail below with reference to FIG. 16. After the rotation process, the filling opening 19 of the transport bag 10 faces towards the laterally arranged loading device 107, which, in the embodiment shown, is a ramp. When the transport bag 10 arrives at the height of the ramp, the overhead conveyor system is stopped in order that the transport bag 10 comes to a standstill in front of the ramp. Then the rear wall 13 of the transport bag 10 is tilted, by means of a pivoting device 113 arranged on the side opposite the ramp, such that the transport bag 10 opens. For this purpose, the pivoting device 113 comprises two pivot arms 114 which are arranged approximately at a spacing that corresponds to the width of the upper wall element 15 but that is so wide that the front wall 12 of the transport bag 10 can be surrounded. As indicated by the arrow M, the pivoting device 113 enters the loading station 104, in the direction of the loading device 107, and in the process the pivot arms 114 travel under the upper wall element 15. This is raised as a result, and the transport bags 10 are brought into the loading position. In this loading position, goods can slide from the loading device 107 into the open transport bag 10. Subsequently, the overhead conveyor system 100 is put into operation again and the transport device 1 is conveyed out of the loading station 104. As soon as the transport bag has been conveyed past the stop, it rotates under the influence of gravity, back into its basic orientation.

In the embodiment shown, the pivot arms 114 are inclined at an angle to the horizontal. As a result, the upper wall element 15 of the transport bag 10 is not completely in a horizontal position in the loading position, but rather is oriented in an inclined position. However, on account of the size of the filling opening 19 it is not essential to move the upper wall element 15 into the horizontal position.

In the embodiment shown in FIG. 15, the lower wall element 16 of the rear wall 13 hangs substantially downwards in a vertical position. However, embodiments are also conceivable in which the lower wall element 16 is obliquely inclined in the loading position of the transport bag 10. This can for example be achieved by a further stop, against which the lower wall element 16 is pressed upon entry of the pivoting device 113. An advantage of the obliquely inclined lower wall element 16 of the rear wall 13 is that sensitive goods can slide along the rear wall 13 into the transport bag 10 during filling, without being damaged.

FIG. 16 shows various stages of the rotation process by means of a stop 112 which is provided for an overhead conveyor system 100 from FIG. 15. For purposes of illustration, only the stop 112 and the transport device 1 are shown in cross-section. The stop 112 is arranged to one side of the conveying direction. When the transport device 1 travels past the stop 112, said device strikes against said stop with the outside edge 22, which results in a torque about the vertical axis V of the transport device 1. In this case, the stop 112 is positioned relative to the rail 101 in such a way that it can cause a rotation about 90°. Preferably, the overhead conveyor system 100 from FIG. 15 comprises a plurality of such stops, in order to be able to maintain the rotated position of the transport device over a longer conveying distance. The stop 112 can be designed as a continuous stop rail which extends beside the rail 101, in the region of the loading station. Preferably, a stop rail of this kind can have a chamfered course in the inlet region of the loading station, the spacing thereof from the transport devices 1 reducing in the conveying direction. As a result, the transport devices 1 are not rotated abruptly, but rather gradually, about the vertical axis V.

### LIST OF REFERENCE NUMBERS

1 transport device
10 transport bag
11 suspension device
12 front wall
13 rear wall
14 coupling mechanism
15 upper wall element
16 lower wall element
17 first C-shaped frame
18 trapezoidal frame part
19 filling opening
20 second C-shaped frame
21 joint
22 outside edge
23 support wall
24 horizontal pin
25 first seam
26 second seam
27 closure element
28 closure
29 pawl
30 funnel-shaped opening
31 receiving space
32 pawl axis
33 slider
34 edge of the rear wall
35 spring
36 side opening
378 actuation lever
38 cover
39 recess
40 support hook
41 bearing element
42 contact surface
45 bar
46 chamfered flank
47 projection
48 recess
49 opening
50 rollers
100 overhead conveyor system
101 rail
102 rail end
103 rail start
104 loading station
105 support arms
106 carousel
107 loading device
108 gripping device
109 lip
110 gripping hook
111 groove
112 stop
113 pivoting device
114 pivot arm
115 joint receptacle
116 pivot mechanism
117 guide rail
G joint axis
R second joint axis
V vertical axis

1. A transport bag for an overhead conveyor system, comprising:
a suspension device for suspending the transport bag from a support hook,
a front wall, and
a rear wall, wherein the rear wall can be coupled to and disengaged from the front wall by means of a coupling mechanism in a lower region of the rear wall,
wherein the front wall comprises a flexible planar material, and
wherein the rear wall comprises two wall elements which are connected to one another in a pivotable manner and shaped such that together they form a filling opening of the transport bag, which filling opening extends in part over the two wall elements.

2. The transport bag according to claim 1, wherein the two wall elements of the rear wall are dimensionally stable along an outside edge of the rear wall and are tiltable relative to one another about a joint axis, wherein the two wall elements are an upper wall element and a lower wall element, and the upper wall element comprises a first C-shaped frame and a frame part that is provided centrally on the first C-shaped frame, wherein the frame part is attached to the first C-shaped frame so as to be rotatable about a second joint axis extending substantially in parallel with the joint axis.

3. The transport bag according to claim 1, wherein one of the two wall elements comprises a planar, in particular dimensionally stable, material.

4. The transport bag according to claim 1, wherein the suspension device is immovably connected to the rear wall and is configured as a U-shaped hook.

5. The transport bag according to claim 1, wherein the coupling mechanism comprises at least one receiving space, and a pawl, on the rear wall,
wherein the receiving space is configured to receive a closure element of the front wall in such that it the closure element is held in the receiving space by the pawl,
wherein the coupling mechanism comprises a release mechanism, such that the pawl can be disengaged in order to release the closure element.

6. The transport bag according to claim 5, wherein the release mechanism comprises a slider, and/or an actuation lever which is provided on the pawl and extends to one side of the transport bag, such that the pawl is movable for releasing the closure element.

7. The transport bag according to claim 5, wherein the receiving space configured for receiving and releasing the closure element of the front wall from the front.

8. The transport bag according to claim 5, wherein the receiving space is delimited by the pawl and an edge of the rear wall opposite the pawl.

9. A support hook for supporting a transport bag of an overhead conveyor system, which comprises a U-shaped hook as a suspension device,
wherein the support hook comprises an immovable bearing element having a contact surface for suspending and supporting the suspension device,
wherein the contact surface is delimited by a curved contour configured to enable an upright rotation of the suspension device out of a basic orientation about a vertical axis extending through the contact surface, about a quarter circle, and in the process simultaneously brings about a continuous movement of the suspension device along the vertical axis, such that the suspension device pushes in the basic orientation due to gravity.

10. The support hook according to claim 9, wherein the transport bag comprises:
a suspension device for suspending the transport bag from a support hook,
a front wall, and
a rear wall, wherein the rear wall can be coupled to and disengaged from the front wall by means of a coupling mechanism in a lower region of the rear wall,
wherein the front wall comprises a flexible planar material, and
wherein the rear wall comprises two wall elements which are connected to one another in a pivotable manner and shaped such that together they form a filling opening of the transport bag, which filling opening extends in part over the two wall elements.

11. The support hook according to claim 9, wherein the bearing element allows for oscillation of the suspension device about all the axes lying in a horizontal plane.

12. The support hook according to claim 9, wherein the contour limits the rotation of the suspension device about the vertical axis to a quarter circle.

13. The support hook according to claim 9, wherein at least two opposing sides of the support hook have outer contours having projections and corresponding recesses, which allows for an interleaved arrangement of neighboring support hooks.

14. A transport device for an overhead conveyor system, wherein the transport device comprises a transport bag and a support hook, the transport bag comprising:
a suspension device for suspending the transport bag from a support hook,
a front wall, and
a rear wall, wherein the rear wall can be coupled to and disengaged from the front wall by means of a coupling mechanism in a lower region of the rear wall,
wherein the front wall comprises a flexible planar material, and
wherein the rear wall comprises two wall elements which are connected to one another in a pivotable manner and shaped such that together they form a filling opening of the transport bag, which filling opening extends in part over the two wall elements.

15. The transport device according to claim 14, wherein the support hook comprises:
an immovable bearing element having a contact surface for suspending and supporting the suspension device,
wherein the contact surface is delimited by a curved contour configured to enable an upright rotation of the suspension device out of a basic orientation about a vertical axis extending through the contact surface, about a quarter circle, and in the process simultaneously brings about a continuous movement of the suspension device along the vertical axis, such that the suspension device pushes in the basic orientation due to gravity.

16. An overhead conveyor system comprising a plurality of transport devices and a rail for conveying the transport devices,
wherein each transport device comprises a transport bag and a support hook, the transport bag comprising:
a suspension device for suspending the transport bag from a support book,
a front wall, and
a rear wall, wherein the rear wall can be coupled to and disengaged from the front wall by means of a coupling mechanism in a lower region of the rear wall,
wherein the front wall comprises a flexible planar material, and
wherein the rear wall comprises two wall elements which are connected to one another in a pivotable manner and shaped such that together they form a filling opening of the transport bag, which filling opening extends in part over the two wall elements,
wherein the transport devices are suspended on the rail during conveying, by the support hook,
wherein the overhead conveyor system comprises a loading station at which the rail is interrupted between a rail end and a rail start,
wherein the transport devices can each be conveyed by support arms in the loading station from the rail end to the rail start, and
wherein a loading device for loading the transport bag is arranged between the rail end and the rail start.

17. The overhead conveyor system according to claim 16, wherein the support arms each comprise a gripping device for gripping the support hook and/or the suspension device and/or the rear wall.

18. The overhead conveyor system according to claim 16, wherein each of the support arms comprises a pivot mechanism by which one of the wall elements of the rear wall of the respective transport bag can be pivoted, in order to bring the transport bag into a loading position.

19. The overhead conveyor system according to claim 16, further comprising at least one guide rail for bringing the transport bag into a loading position, wherein the at least one guide rail is arranged such that, during conveying of the transport devices, one of the two wall elements slides along the guide rail.

20. The overhead conveyor system comprising a plurality of transport devices according to claim 15 and a rail for conveying the transport devices,
wherein the transport devices are suspended on the rail during conveying, by the support hook,
wherein the overhead conveyor system comprises a loading station for loading one of the transport devices in each case,
wherein the loading station comprises a device for rotating the transport bag about the vertical axis about a quarter circle and for relative pivoting of the wall elements, connected to one another in a pivotable manner, relative to one another, in order to set the filling opening for lateral loading in the loading station via a loading device which is arranged to the side of the rail.

21. The overhead conveyor system according to claim 20, wherein the rail is formed continuously through the loading station.

22. The overhead conveyor system according to 16, wherein the loading device comprises a ramp, a conveyor belt, or a slide.
